(19) United States
(12) Patent Application Publication
(10) Pub. No.: US 2015/0072171 A1
(43) Pub. Date: Mar. 12, 2015

(54) HYDROPHOBIC SURFACE TREATMENT COMPOSITIONS COMPRISING TITANIUM PRECURSORS

(71) Applicant: Sri Lanka Institute of Nanotechnology (PVT) Ltd., Pitipana (LK)

(72) Inventors: Palihenage Nadeeka Dushani Tissera, Homagama (LK); Ruchira Nalinga Wijesena, Homagama (LK); Rangana Perera, Homagama (LK); K.M. Nalin de Silva, Homagama (LK)

(73) Assignee: Sri Lanka Institute of Nanotechnology (PVT) Ltd., Pitipana (LK)

(21) Appl. No.: 14/024,879

(22) Filed: Sep. 12, 2013

(51) Int. Cl. C09D 1/00; B05D 3/00; C09D 5/00; B05D 5/00

(52) U.S. Cl. CPC C09D 1/00; B05D 5/00; B05D 3/007; C09D 5/00
USPC 428/702; 427/372.2

(57) ABSTRACT

The invention relates to methods, systems and compositions for surface treatments of substrate surfaces. Specifically, embodiments provided herein are for methods and compositions for imparting hydrophobicity to substrate surfaces. The embodiments provided herein are for methods of imparting hydrophobicity to substrate surfaces comprising the steps of hydrolyzing a solution comprising a titanium precursor to obtain a titania sol, diluting the titania sol solution, treating the substrate surface with the at least one dilution of the titania sol, and drying the treated substrate surface. Further, surface treatment compositions comprising titania sol solutions are provided herein.

### FIELD

This invention relates to methods and compositions for treating substrates with surface treatment compositions comprising titanium precursors, and more particularly to methods and compositions for surface treatments imparting hydrophobicity to substrates.

### BACKGROUND

Many applications utilize the surface properties of substrates. Properties of substrate surfaces can be modified or enhanced using various surface treatment methods. Modified substrate surfaces can exhibit a wide range of beneficial properties. For example, the substrate surface properties of hydrophobicity or hydrophilicity can be modified with surface treatment methods and properties such as water-resistance or water-repellence can be introduced. Surface-modified substrates can be useful in environmental protection and superconduction, and can provide anti-soiling, stain resisting, self-cleaning, or biomimetic properties to substrate surfaces.

In some instances, surface treatment methods utilize surface treatment compositions that can form micro- or nano-structures on the surfaces of substates. Recently, use of nanomaterial compositions for surface modifications has gained popularity. Surface treatments with nanomaterials can provide more efficient, long lasting effects.

Recently, considerable attention has been directed to substrates with hydrophobic surfaces and as a result, tremendous efforts have been made to achieve/improve hydrophobic properties of different types of substrates. The use of hydrophobic polymers grafted on surfaces (to alter the surface energy of the surface), modification of surface morphology to mimic nature (effects of lotus leaf, rose petal, duck feathers, and water sliders) has been reported. See Yan Y, Gao N, Barthlott W, Mimicking natural super-hydrophobic surfaces and grasping the wetting process: A review on recent progress in preparing super-hydrophobic surfaces. Advances in Colloid and Interface Science 169 (2011) 80-105; Feng L, Li S, Li Y, Li H, Zhang L, Zhai J, Song Y, Liu B, Jiang L, Zhu D, Super-hydrophobic surface: from natural to artificial, Adv. Mater. 14 (2002) 1857-1860; Gao X F, Jiang L, Water-repellent legs of water striders, Nature, 432 (2004) 36-36; Shi F, Wang Z. Q, Zhang X, Combining a layer-by-layer assembling technique with Electro chemical deposition of gold aggregates to mimic the legs of water striders, Adv. Mater. 17 (2005) 1005-1009), or grafting of nano particle (See Shi Y. L, Feng X. J, Yang W, Wang F, Han Y. Q. Preparation of Super-hydrophobic Titanium Oxide Film by Sol-Gel on Substrate of Common Filter Paper, J Sol-Gel Sci Technol. 59 (2011) 43-47; Amirhosein B, Ramin K, Mohammad E Y. Fabrication of super-hydrophobic and antibacterial surface on cotton fabric by doped silica-based sols with nanoparticles of copper. Nano scale Research Letters 2011, 6:594; Xue C H, Jia S T, Zhang J, Tian L Q. Super-hydrophobic surfaces on cotton textiles by complex coating of silica nanoparticles and hydrophobization. Thin Solid Films 2009, 517:4593-4598; Hao L F, An Q F, Xu W, Wang Q J. Synthesis of fluoro-containing super-hydrophobic cotton fabric with washing resistant property using nano-SiO2 sol-gel method. Adv Mater Res 2010, 121-122:23-26.), or polyelectrolyte multilayers to impart different surface roughness to achieve the non wettable property on the substrate (See Chao-Hua Xue, Shun-Tian Jia, Hong-Zheng Chen and Mang W. Super-hydrophobic cotton fabrics prepared by sol-gel coating of TiO2 and surface hydrophobization. Sci. Technol. Adv. Mater. 9 (2008) 035001 (5 pp); Yuyang L, Xianqiong C and Xin J H. Hydrophobic duck feathers and their simulation on textile substrates for water repellent treatment. Bioinsp. Biomim. 3 (2008) 046007 (8 pp); Karthik R, Swaminatha K, Mark K, George C, Phillip J, Igor L. Ultra-hydrophobic Textiles Using Nanoparticles: Lotus Approach. Journal of Engineered Fibers and Fabrics http://www.jeffjournal.org Volume 3, Issue 4—2008; Minghua Y, Guotuan G, Wei-Dong M, Feng-Ling Q. Super-hydrophobic cotton fabric coating based on a complex layer of silica nanoparticles and perfluorooctylated quaternary ammonium silane coupling agent. Applied Surface Science 253 (2007) 3669-3673). By selecting and engineering the molecules, surfaces have been developed with wettability that can be reversibly switched from super-hydrophobicity to super-hydrophilicity under UV/VIS irradiation, pH change, or temperature change (See Cheng J, Qihua W, Tingmei W. Thermo responsive PNIPAAm-modified cotton fabric surfaces that switch between superhydrophilicity and superhydrophobicity. Applied Surface Science 258 (2012) 4888-4892; Nicolas V, Yannick C, Vincent T, Rabah B. Wettability Switching Techniques on Super-hydrophobic Surfaces. Nanoscale Research Letters 2007, 2:577-596).

The hydrophilic or hydrophobic properties of surface can be measured by the surface's wettability. A wettable surface is a hydrophilic surface while a non-wettable surface is more hydrophobic. In some instances, depending on the end use of the substrate, a wettable surface is desired, while in some other instances, a non-wettable surface is desired. A wettable surface can be converted to a non-wettable surface and vice versa, using surface modification techniques. Surface wettability to water mainly depends on the difference in interfacial energy of the surface and the water droplet. This phenomenon can be used to achieve a hydrophobic surface using two different approaches; lowering interfacial energy and altering smooth surfaces to rough surfaces (See Chien-Te H, Jin-Ming C, Rong-Rong K, Ta-Sen L, Chu-Fu W. Influence of surface roughness on water- and oil-repellent surfaces coated with nanoparticles. Applied Surface Science 240 (2005) 318-326; Watson G S, Cribb B W, and Watson J A, How micro/nano architecture facilitates anti-wetting: An elegant hierarchical design on the termite wing, ACS Nano, 4 (2010) 129-136; Pozzato A, Dal Zilio S, Fois G, Vendramin D, Mistura G, Belotti M, Chen Y, Natali M. Super-hydrophobic surfaces fabricated by nano imprint lithography. Microelectronic Engineering 2006, 83:884-888; Zhu L B, Xiu Y H, Xu J W, Tamirisa P A, Hess D W, Wong C P. Superhydrophobicity on Two-tier Rough Surfaces Fabricated by Controlled Growth of Aligned Carbon Nanotube Arrays Coated with Fluorocarbon. Langmuir, 2005, 21: 11208-11212; Ma M, Mao Y, Gupta M, Gleason K K, Rutledge G C: Super-hydrophobic fabrics produced by electro spinning and chemical vapor deposition. Macromolecules 2005, 38:9742-9748).

Hydrophobicity of a surface can be measured using the contact angle of a water droplet on the surface. The contact angle can be a static contact angle or a dynamic contact angle. The dynamic contact angle, measured by the contact angle hysteresis of the surface, gives an idea about the wettability of the surface. Using the contact angle hysteresis analysis, one can determine how easy it is for a water drop to move across the hydrophobic surface. See Eral H. B, Mannetje T, Oh J. M. Contact angle hysteresis: a review of fundamentals and applications. Colloid Polym Sci DOI 10.1007/s00396-012-2796-6. Low contact angle hysteresis implies that water can easily slide across the sample surface whereas high contact angle hysteresis implies water will stick to the surface.

Wettability can be represented quantitatively by the static contact angle (hereinafter “contact angle”). The contact angle denotes the angle between a surface and a water drop applied to this surface. Surfaces that form a contact angle larger than 90° with water are referred to as hydrophobic, while surfaces that form a contact angle less than 90° with water are referred to as hydrophilic. Superhydrophobic surfaces have a contact angle larger than 150°.

The contact angle depends on the properties of the liquid as well as the properties of the surface. In particular, the contact angle depends on the surface material and the surface texture or roughness. Hydrophobicity can be introduced to a surface or a surface can be modified to enhance or improve the hydrophobicity by varying the surface roughness.

Generally, two types of wetting behaviors, which are primarily dependent on to the nature and extent of the surface roughness, are possible for hydrophobic surfaces. These two wetting behaviors are called the Wenzel state and the Cassie state. When the roughness of a substrate surface is increased, the surface area of the substrate surface will increase, which confers a geometrical hydrophobic nature to the substrate surface. This is referred to as the Wenzel state. In this state water drops on the surface can penetrate into the cavities of the surface and remain pinned even when the surface is tilted to a high angle. This model of hydrophobicity can be observed in rose pellets and is connected with the high contact angle hysteresis of the surface.

Conversely, in the Cassie state of hydrophobicity, water does not penetrate into the surface cavities of the article. Rather, water droplets stay above surface air pockets and can be easily rolled off when the article is tilted. This model of hydrophobicity can be observed in Lotus leaves and is connected with low contact angle hysteresis of the surface.

When surface roughness is increased, a hydrophobic substrate surface behaves according to the Wenzel model and both contact angle and contact angle hysteresis increase. A further increase in the surface roughness can lead to a transition from the Wenzel model to the Cassie model where the contact angle increases while contact hysteresis starts decreasing. See Sheng Y, Jiang S, Tsao H. Effects of geometrical characteristics of surface roughness on droplet wetting. The Journal of Chemical Physics 127, 234704 2007. Hence, a critical level of surface roughness must be obtained on the surface of the article using an appropriate surface treatment to achieve the required level of hydrophobicity.

The dynamic water contact angle of a hydrophobic substrate surface can give an idea about the wettability (degree of wetting) of the surface and some clues on the degree of surface roughness (regular/irregular or flat/with defects). The dynamic water contact angle can be measured using three basic methods: 1) by changing the droplet volume; 2) by tilting the droplet; and 3) by using a Wilhelmy plate method with force tensiometry.

There are different advantages and disadvantages associated with each of the above mentioned test methods. Normally, water advances over a dry surface and recedes over a wet surface. If the wetting can alter a hydrophobic surface due to a chemical reaction or absorption, receding contact angles will not follow the same path as advancing contact angle. Therefore, such a surface can show a high contact angle hysteresis. Additionally, if the surface is more of a perfectly flat surface, one can observe a zero contact angle hysteresis. However, the theoretical modeling of contact angles on smooth and homogenous surfaces also predicts a high contact angle hysteresis.

The advancing contact angle can be determined using routine methods known to persons of ordinary skill in the art. For example, the advancing contact angles and receding contact angles of the contact lenses can be measured using a conventional drop shape method, such as the sessile drop method or captive bubble method. Advancing and receding water contact angles of silicone hydrogel contact lenses can be determined using a Kruss DSA 100 instrument (Kruss GmbH, Hamburg), and as described in D. A. Brandreth: “Dynamic contact angles and contact angle hysteresis”, Journal of Colloid and Interface Science, vol. 62, 1977, pp. 205-212 and R. Knapikowski, M. Kudra: Kontaktwinkelmessungen nach dem Wilhelmy-Prinzip-Ein statistischer Ansatz zur Fehierbeurteilung“, Chem. Technik, vol. 45, 1993, pp. 179-185, and U.S. Pat. No. 6,436,481.

Hydrophobic defects also can lead to low contact angle hysteresis (lotus effect). Superhydrophobic lotus leaves have 10-micron papillae in combination with a nanostructure created by hydrophobic wax crystals. This combination results in a surface with water contact angles of about 160°, and enables contact angle hysteresis of 5°. A superhydrophobic surface, such as a lotus leaf can cause the water droplets to bead off completely. This results in a self-cleaning surface, since the rolling water droplets remove dirt and debris. The hills and valleys of a lotus leaf (micron-sized papillae) insure that the surface contact area available to water is very low, while the hydrophobic nanoparticles (wax crystal) prevent penetration of water into the valleys. Accordingly, water cannot wet the surface, and forms nearly spherical water droplets, leading to superhydrophobic surfaces.

Over the last few years, creation of the lotus effect was the subject of both fundamental research and practical applications. For instance, the properties of these surfaces can be effectively used for textiles, traffic signs, hulls of ships, tubes or pipes, building glass, windshields of cars, satellite antenna, and conductors with a self-cleaning surface. These surfaces usually have binary structures at both micrometer and nanometer scales, which makes it possible to trap a large amount of air and to minimize the real contact area between surface and water droplets. Reference may be made to Sun, T., et al. Angew. Chem., Int. Ed. 2004, 43, 1146; Feng, L., et al. Angew. Chem., Int. Ed. 2003, 42, 4217; Guo, Z., Zhou, F., Hao, J., Liu, W., J. Am. Chem. Soc. 2005, 127, 15670.

Certain specific techniques are required to create superhydrophobicity. Chemical Vapor Deposition (CVD) has been one such technique. A variation of CVD, hot-filament chemical vapor deposition (HFCVD) allows coating of substrate surfaces with complex shape and nanoscale features. This technique can be used to deposit thin layers of a variety of polymers, including low surface energy polymers such as polytetrafluoroethylene. See United States Patent Application No. 2003/0138645 to Gleason et al.; K K. S. Lau et al., See also “Hot-Wire Chemical Vapor Deposition (HECVD) of Fluorocarbon and Organosilicon Thin Films,” Thin Solid Films, 2001, 395, 288-291.

### SUMMARY

The present invention provides methods and compositions for obtaining hydrophobicity in or increasing the hydrophobicity of substrate surfaces. Specifically, one embodiment of the present invention provides a method of treating substrate surfaces to impart hydrophobicity. According to this embodiment, a solution comprising a titanium precursor is hydrolyzed under acidic conditions to generate a solution comprising a titania sol. The titania sol solution is then diluted with a dilution solvent by a dilution factor of about 70, about 140, about 250, or about 500 to obtain a series of titania sol dilutions. Substrate surfaces are then treated with at least one of the titania sol dilutions. In this process, nanoparticles (for example titanium dioxide nanoparticles or silica nanoparticles) are not precipitated onto the treated surface of the treated substrate. The treated substrate surface is then dried.

Another embodiment of the invention provides a hydrophobic surface treatment composition comprising a titanium precursor, at least one protic solvent, and an aqueous solution of inorganic or an organic acid. The surface treatment composition of this embodiment is diluted with a dilution solvent to any dilution factor of up to 500. Again, in this composition, nanoparticles (for example titanium dioxide nanoparticles or silica nanoparticles) are not precipitated onto the treated surface of the treated substrate.

Other aspects and advantages of embodiments of the invention will be apparent from the following description and the appended claims.

### BRIEF DESCRIPTION OF THE DRAWINGS

FIG. 1A is a scanning electron microscope image of normal untreated cotton fabric;

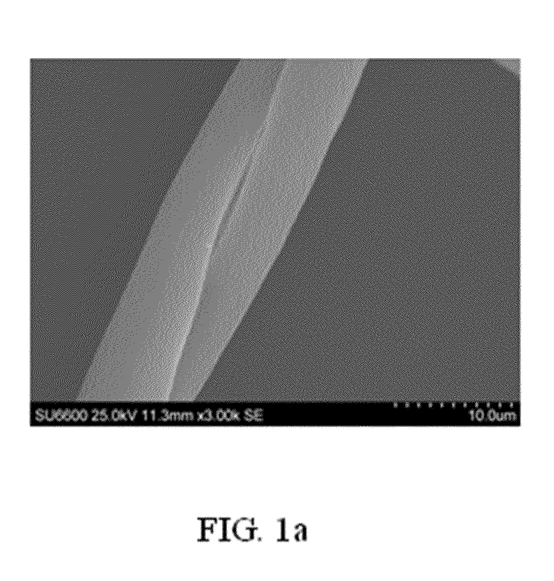

FIG. 1B is a scanning electron microscope image of cotton fabric treated according to one embodiment of the present invention;

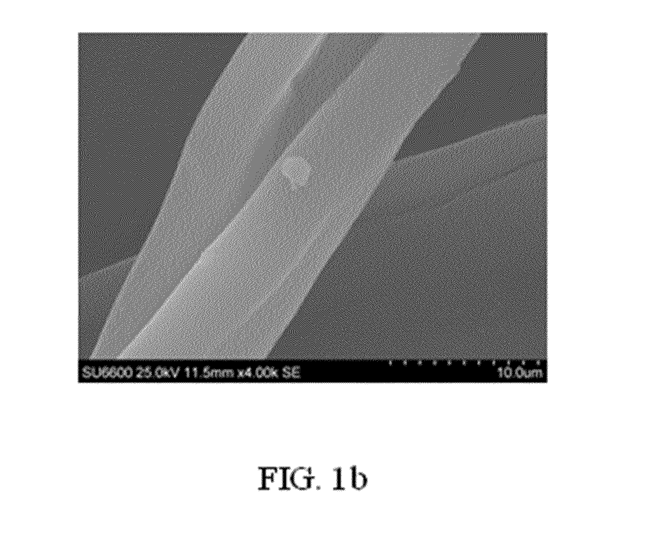

FIG. 2A is a graph depicting the surface roughness of normal untreated cotton fabric measured using Atomic Force Microscopy;

FIG. 2B is a graph depicting the surface roughness of cotton fabric treated according to one embodiment of the present invention measured using Atomic Force Microscopy;

FIG. 3 shows Fourier Transformed Infrared Spectroscopic graphs depicting the chemical composition of normal cotton fabric and the cotton fabric treated according to one embodiment of the invention;

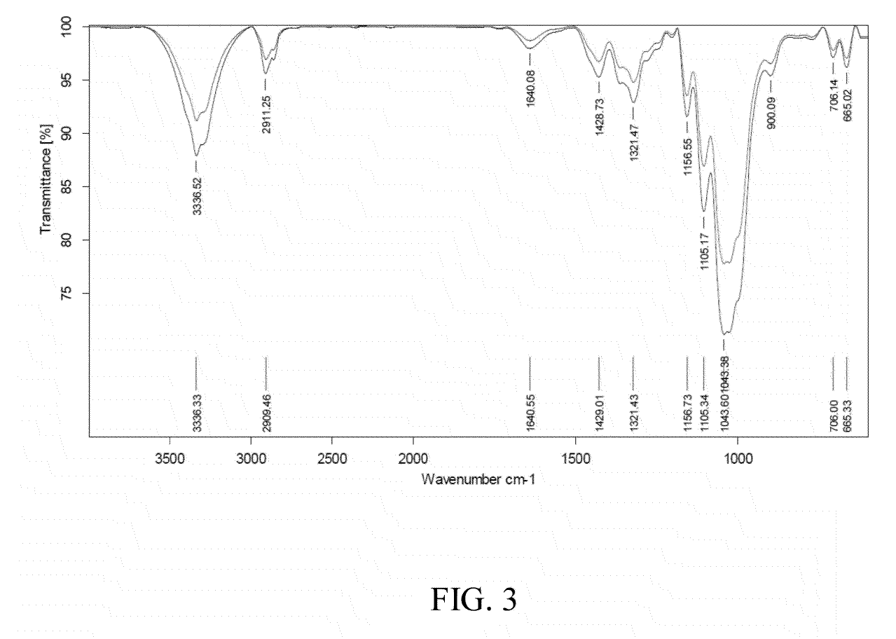

FIG. 4 depicts the UV blocking abilities of cotton fabric treated according to one embodiment of the invention and normal cotton fabric; and

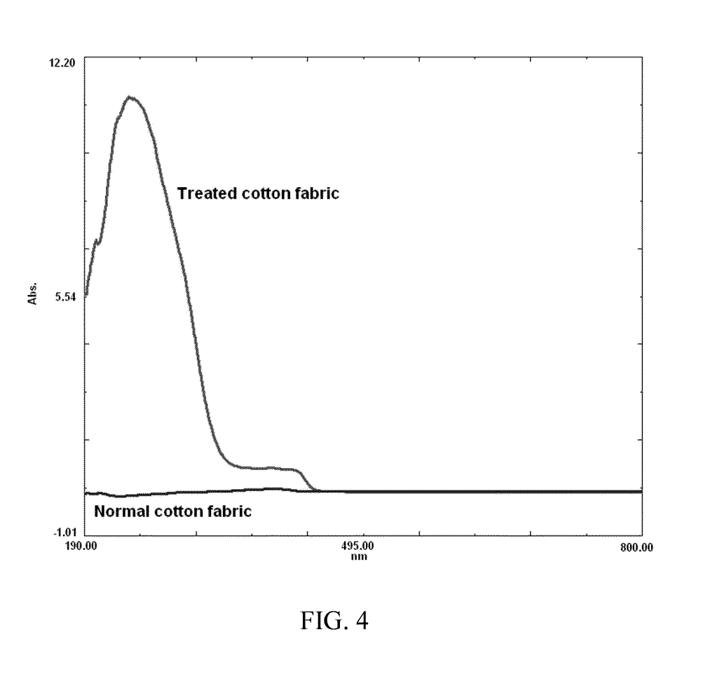

FIG. 5 is a schematic diagram of the test setup for the dynamic water resistance test.

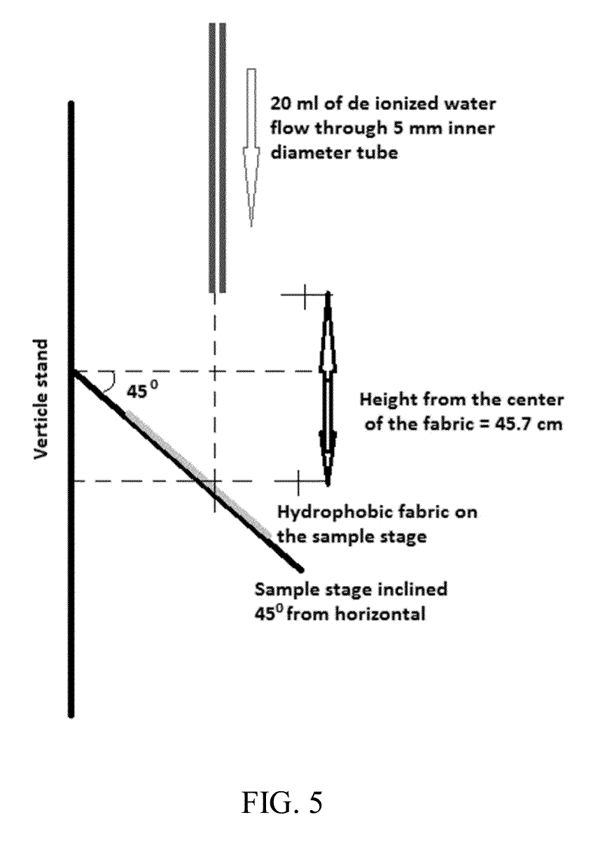

### DETAILED DESCRIPTION

Certain embodiments disclosed herein provide for methods and compositions for surface treatment of substrate surfaces with titania sols to impart hydrophobicity.

After reading this description, it will become apparent to one skilled in the art how to implement the invention in various alternative embodiments and alternative applications. However, although various embodiments of the present invention will be described herein, it is understood that these embodiments are presented by way of example only, and not limitation. As such, the detailed description of various alternative embodiments should not be construed to limit the scope or the breadth of the invention.

The disclosure herein provides methods and compositions that can be used to confer certain beneficial properties or modify or enhance certain beneficial properties of the surfaces of substrates. In one embodiment, a method of treating a substrate surfaces to impart hydrophobicity is provided. The surfaces include, but are not limited to, textile, wood, paper, metal, ceramic, glass, fiber, and polymer surfaces. In some particular embodiments, the substrate surface is a fabric surface. In some embodiments, the fabric may be cotton, nylon or polyester.

As used herein “treating a substrate surface” means subjecting the substrate surface to a surface treatment using a substrate treatment composition. In some embodiments, treating a substrate surface may include incorporating the surface treatment composition into the substrate surface. In some embodiments, treating a substrate surface may include coating, adhering, or absorbing the surface treatment composition on the substrate surface.

In some particular embodiments, the coating of a substrate includes either spraying the substrate with the surface treatment composition or dipping the substrate in the surface treatment composition. Any techniques known within the skill of art can be used for either spraying of dip coating.

To “impart hydrophobicity” in the present context means any one of introducing hydrophobicity to a substrate surface that is not hydrophobic, improving or enhancing the hydrophobicity of a substrate surface that has at least some hydrophobicity, or converting an otherwise hydrophilic surface to a hydrophobic surface. In some embodiments, the term “impart hydrophobicity” may mean converting one hydrophobic state to another hydrophobic state, for example from Wenzel model of hydrophobicity to Cassie model of hydrophobicity and vice versa.

Some embodiments of the methods of imparting hydrophobicity to substrate surfaces, comprise first, the step of hydrolyzing a solution comprising a titanium precursor to obtain a titania sol. The titanium precursor can be selected from any one of titanium alkoxide, titanium halide, titanium nitrate, titanium sulfate, or a similar substance. In some embodiments, the titanium precursor is of the formula Ti(OR)₄, where R is a C₂-C₆ linear or branched chain alkyl group. In some embodiments, the titanium precursor is titanium tetraisopropoxide or titanium tetrabutoxide.

Hydrolysis of the titanium precursor can be carried out under acidic conditions. In some embodiments, hydrolysis can be carried out in an acidic solution. In such embodiments, either inorganic acids or organic acids can be used. In some embodiments, inorganic acids such as nitric acid, hydrochloric acid, sulfuric acid and similar acids can be used. In some other embodiments, organic acids such as acetic, lactic, citric, maleic, malic or benzoic acid can be used. In some embodiments, any combination of inorganic acids and organic acids provided herein can be used. For example, in some embodiments, a mixture of nitric acid and acetic acid can be used.

The hydrolysis reaction can be done in an aqueous solution and most preferably is completed in about 6 hours. In some embodiments, a mixture of water and a water soluble protic solvent can be used. For example, protic solvents such as methanol, ethanol, isopropanol and similar solvents can be used. In some embodiments, the titanium precursor can be dissolved in either water, a protic solvent, a mixture of water/protic, or a mixture of protic solvents. In some embodiments, an acidic solution can be used. In these embodiments, the resultant acidic solution is stirred at ambient temperature until a hydrolyzed solution of titanium precursor is obtained.

Next, according to some embodiments, the titania sol is diluted with a dilution solvent by a dilution factor of either about 70, 140, 250, or 500 to obtain a titania sol dilution. In some embodiments, the dilution solvent is water. In some other embodiments, the dilution solvent is a protic solvent such as methanol, ethanol, or isopropanol. In some other embodiments, the dilution solvent is a mixture of water/protic solvent or a mixture of protic solvents. Although some embodiments provide for a dilution, in some embodiments, it is envisioned that substrate surfaces can be treated directly without any further dilution. Following dilution, a substrate surface can be treated with any one of the dilutions. For example, in some embodiments, sample surfaces can be treated with any one of about a 70 factor dilution, about a 140 factor dilution, about a 250 factor dilution, about a 500 factor dilution, or any factor dilution within the range of about 70 to about 500. According to some embodiments, the sample surfaces can be coated with at least one of these dilutions. A dip coating or spray coating application method can be used.

In some embodiments, coating the substrate surfaces with the titania sol solution does not result in any chemical change of the substrate surface. Accordingly, the substrate surfaces can be further functionalized with appropriate agents.

The coated substrate surfaces can then be dried. The drying can be done at ambient temperature. In some embodiments, the coated substrate surfaces can be dried at an oven temperature of 40° C. to 120° C. In some embodiments, the sample surfaces can be dried by blowing heated air. The drying process can be amenable to industrial scale, and any known drying process can be used. The solvent system can be chosen judiciously, as discussed above. For example, low boiling solvents such as methanol, ethanol and isopropanol can be used, such that these solvents can be dried at ambient temperature. Additionally, mixing these solvents with water creates a solvent system that can be evaporated at a lower temperature than pure water.

The drying process leaves nanomolecules of titanium on the substrate surface that create microstructures therein. In some embodiments, these microstructures are temporary and can be removed. In some of these embodiments, the treated substrate surfaces can be washed with appropriate solvents, such as water, and the substrate surfaces can be returned to their initial state. In some other embodiments, titanium nanomolecules can form permanent microstructures. In these cases, the hydrophobic surface can be said to have “controlled hydrophobicity.” In some of those embodiments, the titania sol can be mixed with an adhesion promoter such as an acrylic polymer or polyurethane polymer and can be permanently affixed to a substrate surface. In other embodiments, the titania sol can form electrostatic bonds with functional groups such as carboxylic or amide groups on the surface of materials that either naturally contain these functional groups or contain these functional groups after modification. For example, surfaces such as textile, wood, paper or glass can be chemically modified with carboxylic or amide functional groups. The titania sol can then be applied to the modified surface and will form permanent electrostatic bonds with the functional groups on the modified surfaces. Accordingly, the present methods can be used to generate temporary or permanent hydrophobic surfaces, depending on need and temporal preference.

Unlike prior art processes, such as those described in U.S. Pat. No. 8,309,167 and the article cited above entitled “Superhydrophobic cotton fabrics prepared by sol-gel coating of TiO₂ and surface hydrophobization” by Xue et al., the method of the present invention does not cause nanoparticles of TiO₂ to be precipitated onto the surface of the substrate. These prior art processes increased surface roughness by precipitating nanoparticles onto a substrate surface in order to increase hydrophobicity.

Additionally, because nanoparticles of TiO₂ are not precipitated onto the substrate surface, the titania sol surface coating allows for the surface to be temporarily made hydrophobic, unless made permanently hydrophobic for example by mixing the titania sol with an adhesion promoter.

Further, unlike the process described in “Superhydrophobic cotton fabrics prepared by sol-gel coating of TiO₂ and surface hydrophobization” the process of creating a titania sol is most preferably completed in less than about 6 hours.

Additionally, unlike the process described in “Superhydrophobic cotton fabrics prepared by sol-gel coating of TiO₂ and surface hydrophobization”, in the present invention, no additional surface energy lowering agent, such as PFTDS is required to be used to lower the surface energy of the treated surface.

### Surface Characterization

In addition to imparting hydrophobicity, treatment with the titania sol solution may confer several other beneficial properties to the substrate surfaces. For example, in some embodiments, the treated substrates surfaces can have one or more of self-cleaning, UV blocking, anti-soiling, stain resisting, and antifogging properties.

The terms “self-cleaning”, “self-cleaning surface”, and “self-cleaning layer” can be used interchangeably and are meant to comprise surfaces/layers that, through treatment with titania sol solutions, are resistant to dirt and/or contamination, or can prevent, remove or disintegrate organic and/or inorganic dirt/undesired material and/or micro-organisms from adhering/contaminating the surface/layer.

The self-cleaning effects can be explained by comparison to a lotus leaf. The lotus leaf has crystalline-type elevations having structures up to a few micrometers apart. Water drops come into contact substantially only with the tips of these elevations, so that the contact area between the leaf surface and the water drop is minimal. In addition, waxy micropapillae are present within the microscale grooves. As such, water droplets roll off of the surface, rather than pinning inside the grooves. As they roll off the water droplets carry with themselves dirt and other contaminants. This “lotus leaf effect” is present in the coated surfaces of the embodiments provided herein. Such surfaces have many applications, for example, surfaces of many structures that are susceptible to build up of ice, water, fog and other contaminants.

Surprisingly and unexpectedly, all the sample surfaces treated with any of the titania sol dilutions were found to exhibit hydrophobic properties. For example, sample surfaces treated with the dilutions as high as about 70, or even about 500, were found to have hydrophobic properties. See Table 2. As discussed before, a low contact angle hysteresis indicates a hydrophobic surface. Surprisingly, in some of the embodiments, even with a high contact angle hysteresis, treated sample surfaces were found to have high hydrophobicity. As such, a fabric treated with 70 factor dilution scored 1 in the water repellence test. The dynamic water resistance (fabric weight gain % after impinging water) of this treated fabric was 35. Accordingly, this treated fabric has a high water repellency and a high water resistance, yet has a high contact angle hysteresis of 44. Without wishing to be bound by a theory, it is proposed that superhydrophobic properties are imparted to the low dilution sample, e.g., 70 dilution, because the Cassie state of hydrophobicity was achieved due to the increase in the substrate's surface roughness due to application of the solution. It is proposed that a high contact angle hysteresis is observed due to the increase in the surface roughness leading to the surface being not regular. Irregular surfaces with some defects may lead to a high contact angle hysteresis. Even with such a high contact angle hysteresis, the treated fabric achieved superhydrophobic properties. See entry 1, Table 2.

On the other hand, with the higher dilution samples, (e.g. 250, 500 dilutions), the sample surfaces show a low contact angle hysteresis. Although these sample surfaces are expected to have high hydrophobicity, surprisingly, it was found that the dynamic water resistance of these surfaces is low. However, these surfaces were found to have good water repellency. See entry 4, Table 2. Accordingly, it is proposed that the sample surface may be a smooth surface, allowing the water to slide off easily over the surface.

Accordingly, the present embodiments provide methods and compositions that can functionalize a substrate surface with a titanium-based nanocoating. Such embodiments render the substrate surface hydrophobic. Additionally, in addition to hydrophobicity, other desirable properties such as self-cleaning, UV blocking, antifogging and the like can be achieved with the surface treatments methods provided herein. Further, the processes provided herein are rather simple, compared to the general methods of surface functionalization that requires techniques such as CVD.

### Sample Preparation

### Example 1

### Preparation of Hydrolyzed Titanium Based Solutions

(a) Titania sol was prepared by hydrolysis of Titanium Tetra Isopropoxide in a large excess of acidified water. In this procedure Titanium (IV) Isopropoxide (TTIP) was added drop-wise, under vigorous stirring, to a room temperature water ethanol mixture (with the ratio of the volume of H₂O/Ethanol in a range from about 10-2 and the ratio of H₂O/Ti in the range from about 90-10) acidified with Nitric acid and Acetic acid (with the ratio of concentrated Acetic acid/Nitric acid in a range from about 18-8 and the ratio of Nitric acid H⁺/Ti in a range from about 0.2-3). A transparent solution was obtained and the mixture was stirred for 1.5 h at room temperature.
(b) Titania sol was prepared by hydrolysis of Titanium Tetra Isopropoxide in a large excess of acidified water. In this procedure Titanium (IV) Isopropoxide (TTIP) was added drop-wise, under vigorous stirring, to a room temperature water ethanol mixture (with the ratio of the volume of H₂O/Ethanol in a range from about 10-2 and the ratio of H₂O/Ti in the range from about 90-10) acidified with Nitric acid (with the ratio of H⁺/Ti in the range from about 0.2-3). A transparent solution was obtained and the mixture was stirred for 1.5 h at room temperature.
(c) Titania sol was prepared by hydrolysis of Titanium Tetra Isopropoxide in a large excess of acidified water. In this procedure Titanium (IV) Isopropoxide (TTIP) was added drop-wise, under vigorous stirring, to a room temperature water methanol mixture (with the ratio of the volume of H₂O/Methanol in the range from about 10-2 and the ratio of H₂O/Ti in the range from about 90-10) acidified with Nitric acid and Acetic acid (with the ratio of concentrated Acetic acid/Nitric acid in the range from about 18-8 and with the ratio of Nitric acid H⁺/Ti in the range from about 0.2-3). A transparent solution was obtained and the mixture was stirred for 1.5 h at room temperature.
(d) Titania sol was prepared by hydrolysis of Titanium Tetra Isopropoxide in a large excess of acidified water. In this procedure Titanium (IV) Isopropoxide (TTIP) was added drop-wise, under vigorous stirring, to a room temperature water methanol mixture (with the ratio of the volume of H₂O/Methanol in the range from about 10-2 and the ratio of H₂O/Ti in the range from about 90-10) acidified with Nitric acid (with the ratio of H⁺/Ti in the range from about 0.2-3). A transparent solution was obtained and the mixture was stirred for 1.5 h at room temperature.
(e) Titania sol was prepared by hydrolysis of Titanium Tetra Isopropoxide in a large excess of acidified water. In this procedure titanium (IV) Isopropoxide (TTIP) previously dissolved in anhydrous methanol (with the ratio of the volume of Methanol/Ti in the range from about 10-23) was added drop wise, under vigorous stirring, to a room temperature water (with the ratio of H₂O/Ti in the range from about 90-10) acidified with Nitric acid and Acetic acid (with the ratio of concentrated Acetic acid/Nitric acid in the range from about 18-8 and with the ratio of Nitric acid H⁺/Ti in the range from about 0.2-3). A transparent solution was obtained and the mixture was stirred for 1.5 h at room temperature.
(f) Titania sol was prepared by hydrolysis of Titanium Tetra Isopropoxide in a large excess of acidified water. In this procedure titanium (IV) Isopropoxide (TTIP) previously dissolved in anhydrous methanol (with the ratio of the volume of Methanol/Ti in the range from about 10-23) was added drop wise, under vigorous stirring, to a room temperature water (with the ratio of H₂O/Ti in the range from about 90-10) acidified with Nitric acid (with the ratio of H⁺/Ti in the range from about 0.2-3). A transparent solution was obtained and the mixture was stirred for 1.5 h at room temperature.

### Example 2

### Preparation of Hydrophobic Articles

(a) Cotton fabric is then dipped in any one of the solutions prepared in example 1 (a-f) (with a fabric to solution ratio of 1:20) for 45 minutes. The treated sample can then be dried in an oven with a temperature of 50° C.
(b) Cotton fabric is then dipped in any one of the solutions prepared in example 1 (a-f) (with a fabric to solution ratio of 1:20) for 45 minutes. The treated sample can then be dried under sunlight.

### Example 3

### Preparation of Hydrophobic Articles with Different Surface Roughness to Achieve a Different Model of Hydrophobicity

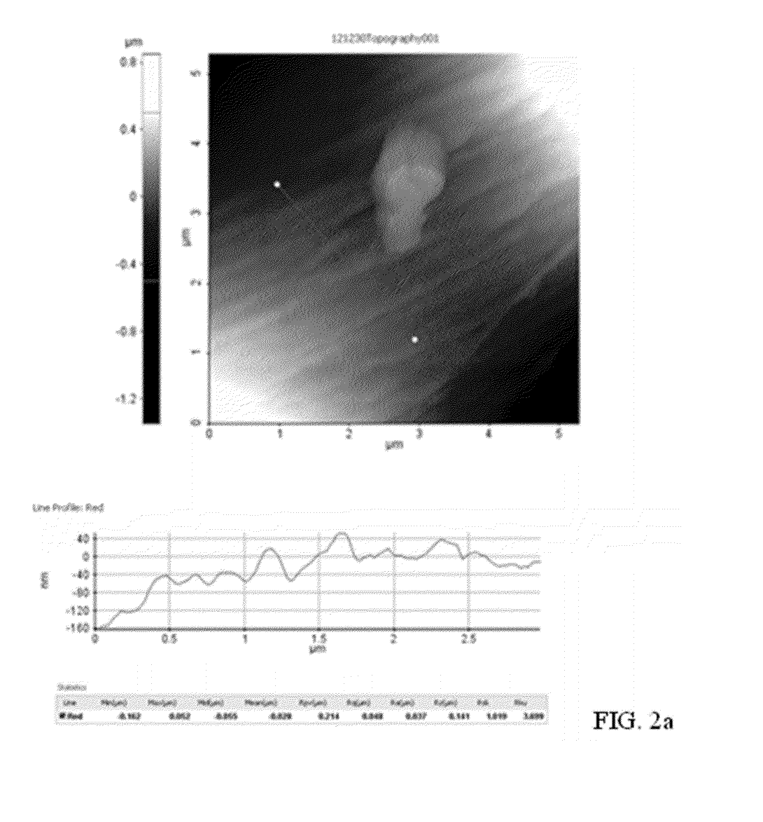

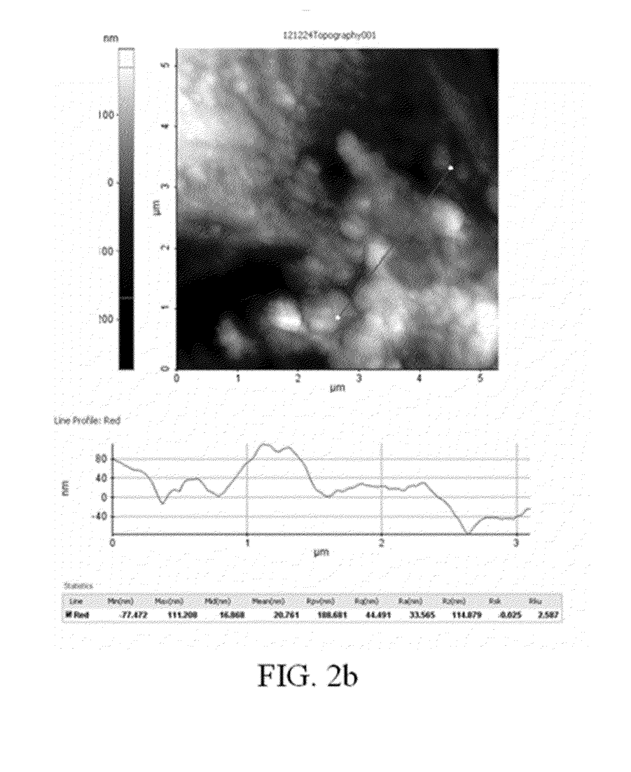

The solutions prepared in example 1 (a-f) are then diluted with distilled water at volume dilution factors of 70, 140, 250 and 500. Cotton fabric samples are then dipped in the diluted solutions for 45 minutes and then dried in an oven at a temperature of 50° C. until dry. The samples' surface roughness and dynamic and static contact angles were measured using atomic force microscope for these treated articles. Table 2 shows the variation of contact angle hysteresis and FIG. 2B depicts the degree of surface roughness of a treated sample. It is therefore observed that the hydrophobic material can be transformed from the Cassie state to the Wenzel model of hydrophobicity by changing the concentration of the titania in the solution.

Hydrophobicity of the treated cotton fabrics were measured adhering to similar testing procedure described in US 2001/000530 A1 (Treatment of fibrous substrates impart repellence, stain resistance and soil resistance), which is incorporated herein in its entirety.

### Test Method and Testing Procedure for Hydrophobicity:

(1) Water repellence test: Treated hydrophobic cotton samples were tested for water repellence. During these tests the fabric samples were evaluated for the penetration of blends of deionized water and Isopropyl Alcohol (IPA). Each blend was assigned a rating as given in Table 1 below.

TABLE 1
Water/IPA blend with water repellence rating

| Water repellence | Water/IPA blend |
|---|---|
| rating number | (% by volume) |
| F | (Fails water) |
| 0 | 100% |
| 1 | 90/10 |
| 2 | 80/20 |
| 3 | 70/30 |

During this test a treated fabric sample was placed on a flat, horizontal surface. Five small drops of water or a water/IPA mixture were gently placed at points at least two inches apart on the surface of the sample. If after observing for ten seconds, four of the five drops are visible as a sphere or a hemisphere, the sample is deemed to pass the test. The reported water repellence rating corresponds to the highest numbered water or water/IPA mixture for which the treated hydrophobic fabric sample passes the described test.
(2) Dynamic water resistance test: During this test the fabric sample was inclined at an angle of 45° from horizontal and 20 ml of deionized water was released on to the centre of the fabric though a glass tube with a 5 mm inside diameter positioned 45.7 cm above the test sample as shown in FIG. 6. The increase in weight of the sample was measured after the release from the tube. This test was performed three times for each sample to get an average value for the increase in weight of the fabric. If the weight gain of the sample was lower it indicates the measured sample has a better dynamic water repellence property, since the fabric was absorbing less water.
(3) Dynamic contact angle test: Similar to the static sessile drop method, the dynamic sessile drop method measures the contact angle between the water drop and the fabric surface. During this test method a syringe pump was used to inject water continuously at a constant rate onto the sample surface. A series of images were captured at a constant time rate. The largest contact angle possible without increasing the solid/liquid interfacial area was measured and noted as the advancing angle. At the end of the advancing contact angle sequence the syringe pump was reversed and water was withdrawn from the drop. The contact angle was measured for the smallest possible angle, which was measured as the receding angle. The difference between the advancing and receding contact angle was calculated as the contact angle hysteresis.
   The contact angle of the water droplet was measured using an image processing program developed using MAT LAB®.

### Summary of Results for Hydrophobicity:

TABLE 2
Summary of hydrophobicity test results

| | | Dynamic water | |
|---|---|---|---|
| | | resistance (fabric | |
| | Water repellence | weight gain % after | Contact angle |
| sample number | test rating | releasing water) | hysteresis |
| 1 (70 diluted) | 1 | 35 | 44 |
| 2 (140 diluted) | 1 | 38 | 27 |
| 3 (250 diluted) | 1 | 60 | 12 |
| 4 (500 diluted) | 1 | 149 | 10 |

According to the observed test results as given in Table 2, the 500 dilution sample showed the lowest contact angle hysteresis and highest water absorbance percentage and it also had the lowest contact angle)(140°) compared to other samples.
With the test results obtained as summarized in above section, the following determinations were made.
As the dilution of the tested samples increases, the maximum static contact angle decreases.
As the dilution of the tested samples increases, water resistance decreases according to results obtained in the dynamic water resistance test and water repellency test.
High dilution factors lead the samples to be less water resistant but water droplets can still easily slide across the surface of the samples. This implies samples have a smooth surface. Low water resistance may be attributed to surface treatment being washed off by the falling water (20 ml of water falling from 46 cm height).
Super hydrophobic properties were achieved for low dilution samples (below 70 times diluted) because of a possible achievement of the Cassie state due to growth of micro bumps (surface roughness) on the surface. This is because if the surface has some irregular roughness with some defects it will lead to a high contact angle hysteresis as observed during the dynamic contact angle measurement test. High water resistance may be attributing to the thick hydrophobic coating achieved on the surface which was not easily washed off by the released water.
   The following tests were performed to measure the natural soiling behavior of the treated cotton hydrophobic fabrics.

### Testing Procedure for Soiling Resistance:

(1) Resistance to Soiling: Fabric swatches with the dimension of 12 cm×12 cm were held on a tilted platform (at an angle of inclination of 60°) and the specified amount of soling material was applied at the top and allowed to drip off for 30 seconds, the residue was collected in a large pre-weighed plastic weighing boat and weighed to quantify the soiling material run-off. From that amount, the % of runoff was measured.

TABLE 3
Soiling Materials Used

| | Name | | |
|---|---|---|---|
| | of | | Soiling |
| | soiling | | Material |
| No | material | Preparation | Amount |
| 1 | Diluted | 1 g Sri Lankan red mud suspended in 5 ml of | 0.3 g |
| | mud | water | |
| 2 | Coffee | Nescafe Coffee (black) 5 g coffee in 150 ml | 0.2 ml |
| | | boiling water, ALLOW TO COOL BEFORE USE | |
| 3 | Tea | Lipton Tea (black) 5 G in 150 ml boiling water, | 0.2 ml |
| | | ALLOW TO COOL BEFORE USE | |

### Summary of Results for Soiling Resistance:

TABLE 4
Measured % of soiling material runoff

| | % run off of the soiling material/stain | | |
|---|---|---|---|
| | | Sample 1 (70 times | Sample 2 (140 times |
| Stain | Normal fabric | diluted) | diluted) |
| Tea | 24 | 87 | 80 |
| Coffee | 31 | 80 | 82 |
| Mud | 20 | 78 | 91 |

With the test results obtained as summarized in the tables 3 and 4 above, treated hydrophobic fabrics showed superior soiling repellence towards particulate type stains. Water-based stains such as tea and coffee also showed a better stain repellence with treated fabric compared to normal cotton fabric. With the higher sample surface roughness due to a higher concentration of nanocoating (e.g., sample 1 and sample 2), the samples behaved according to the Cassie model of hydrophobicity. Therefore a high repellence towards water-based stains is possible with a hydrolyzed titanium-based solution as described above.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent presently preferred embodiments of the invention and are therefore representative of the subject matter broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A method of imparting hydrophobicity to a surface without precipitating nanoparticles on said surface comprising:
(a) hydrolyzing a solution comprising a titanium precursor to obtain a titania sol;
(b) diluting said titania sol by a dilution solvent by a factor of up to 500 to obtain a titania sol dilution;
(c) treating said surface with said titania sol dilution; and
(d) drying said surface.

2. The method of claim 1, wherein the surface is selected from the group consisting of textile, wood, paper, metal, ceramic, polymer, and glass.

3. The method of claim 1, wherein the dilution solvent is water.

4. The method of claim 1, wherein the titanium precursor is selected from the group consisting of titanium alkoxide, titanium halide, titanium nitrate, and titanium sulfate.

5. The method of claim 4, wherein the titanium alkoxide is selected from the group consisting of titanium tetraisopropoxide and titanium tetrabutoxide.

6. The method of claim 1, wherein the hydrolysis of the solution comprising titanium precursor is acidic hydrolysis.

7. The method of claim 1, wherein treating the surface with the titania sol dilution comprises coating the surface with the titania sol dilution.

8. The method of claim 7, wherein coating the surface comprises at least one of spraying the surface with the titania sol dilution and dipping the surface in the titania sol dilution.

9. The method of claim 1, wherein the drying of surface comprises drying at ambient temperature.

10. The method of claim 1, wherein the drying of surface comprises drying at a temperature of about 40° C. to about 120° C.

11. A hydrophobic surface comprising a titania sol diluted by a factor of up to 500, wherein said titania sol comprises a titanium precursor, at least one protic solvent, and at least one inorganic or organic acid.

12. The method in claim 1, wherein the titania sol is mixed with an adhesion promoter.

13. The method of claim 1, wherein the surface contains carboxylic groups or amide functional groups.

14. The method of claim 1, wherein the method step of hydrolyzing a solution comprising a titanium precursor to obtain a titania sol is completed in less than about 6 hours.

15. The method of claim 1, wherein no TiO₂ nanoparticles are precipitated on said surface.
